(19) United States
(12) Patent Application Publication
(10) Pub. No.: US 2009/0118668 A1
(43) Pub. Date: May 7, 2009

(54) MedStar thermo electric H.C. dispenser

(76) Inventor: Jerome Stuart Bixby, Sacramento, CA (US)

Correspondence Address: Jerome Stuart Bixby, Unit #1, 5840 Peppermill Court, Sacramento, CA, 95841, US

(21) Appl. No.: 11/982,938

(22) Filed: Nov. 6, 2007

(51) Int. Cl. A61J 7/00

(52) U.S. Cl. 604/77; 222/146.1

(57) ABSTRACT

I wish to disclose the invention of a thermo-electric “hands-free” drink dispenser which allows the user to get themselves a nice warm or cool drink without assistance. To accomplish this convenience, there is a wand assembly protruding from the top of he unit that has horizontal and vertical movement. The wand is 18 inches long with straw holders that retain a 24 inch long jointed drinking straw. The rest of the components; the on/off switch, the electrical scale with digital readout, a temperature gauge and a custom made stand comprise the balance of the unit in total.

### CROSS REFERENCE TO RELATED APPLICATIONS

Not applicable

### STATEMENT REGARDING FEDERALLY SPONSORED RESEARCH OR DEVELOPMENT

Not applicable

### REFERENCE TO A MICROFICHE APPENDIX

Not applicable

### BACKGROUND OF THE INVENTION

The invention related to a drink dispenser that allow the elderly, the infirm and others that are physically impaired to get themselves a drink, without assistance. Currently, when someone is thirsty and are too frail to get themselves a drink they must rely on someone else to bring them a drink. The MedStar drink dispenser solves that problem. The F.D.A. will classify the invention as a “Class I Daily Activity Assist Device”, and is designed to be used by health care providers in hospitals, nursing facilities and in-home care. The Invention has met the F.D.A test as being safe and effective.

### BRIEF SUMMARY OF THE INVENTION

The person who is in charge of caring for someone who cannot get a drink without assistance simply places the drink dispenser in a position close enough for easy access to the drinking straw. The wand with a jointed, elongated drinking straw has vertical and horizontal movement. The drink dispenser maybe positioned on a stand or a bedside table. The original concept of the design occurred several years ago when my Mother Margaret was living with us. She was elderly, very frail and had palsy in her hands. She was embarrassed and humiliated if the glass of water slipped out of her hand and spilled on the floor. I was determined to help her therefore, the MedStar Thermo Electric H. C. Drink Dispenser. Unfortunately my mom passed away before the drink dispenser came into fruition. The design has been modified through the years. The invention has never been used or sold as of this date.

### BRIEF DESCRIPTION OF THE SEVERAL VIEWS OF THE DRAWINGS

FIG. 1 is a view of the complete thermo electric unit with all of the components in one place; the 16 oz drink container (see cutout), the on/off switch, the scale display module, the temperature gauge and the wand assembly with the elongated drinking straw embedded in the straw holder. One end of the electric cord is ready to plug in to a socket in the back of the unit and the transformer is ready to plug into an electric wall socket. The battery door is open showing (2) AA batteries. The unit dimensions are in the lower right hand corner of the page.

FIG. 2 is a replica of the view shown on FIG. 1, except that the door is open showing the placement of the scale platform. The battery door is closed. A 16 oz drink container which fits on the 3 in.×3 in. scale platform is also shown.

FIG. 3 is a partially exploded view of the unit showing the wand assembly removed from the opening on the top of the unit. The numbers related to all of the components of the unit.

FIG. 4 is a separate view of the electronic scale assembly. The numbers relate to all of the components of the scale.

FIG. 5 is a view of the built-in system for calibration of the electronic scale. When a full 16 oz container is placed on the scale platform the digital read out will read 16 oz, and a green lamp will come on. As the liquid in the container is consumed, the digital read out will register the appropriate number of ounces remaining. When only 2 oz remain in the container and amber waning lamp will come on, and the green lamp goes off. When the container is empty the amber lamp goes off, and the red lamp comes on.

FIG. 6 is an exploded view of the components of the temperature gauge and it's placement on the thermo electric unit.

FIG. 7 is a view of the custom-made stand, made specifically for the MedStar thermo electric unit.

### DETAILED DESCRIPTION OF THE INVENTION

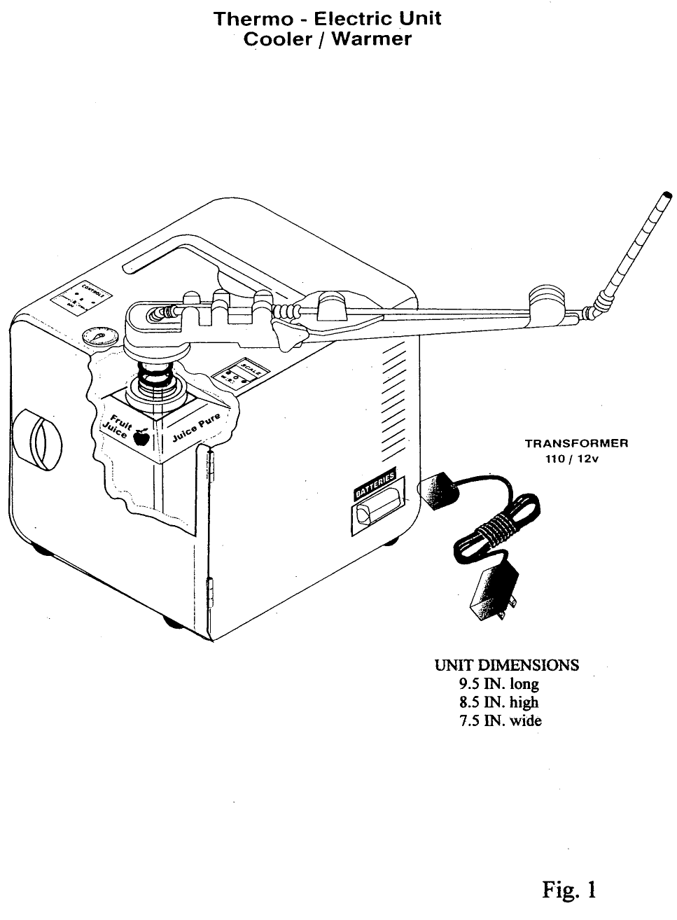

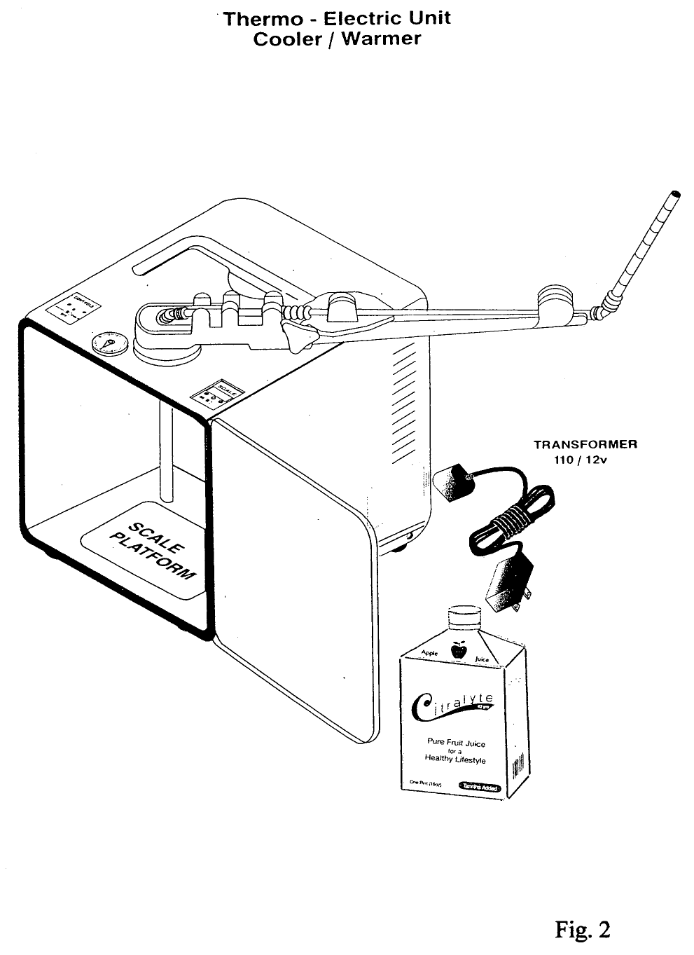

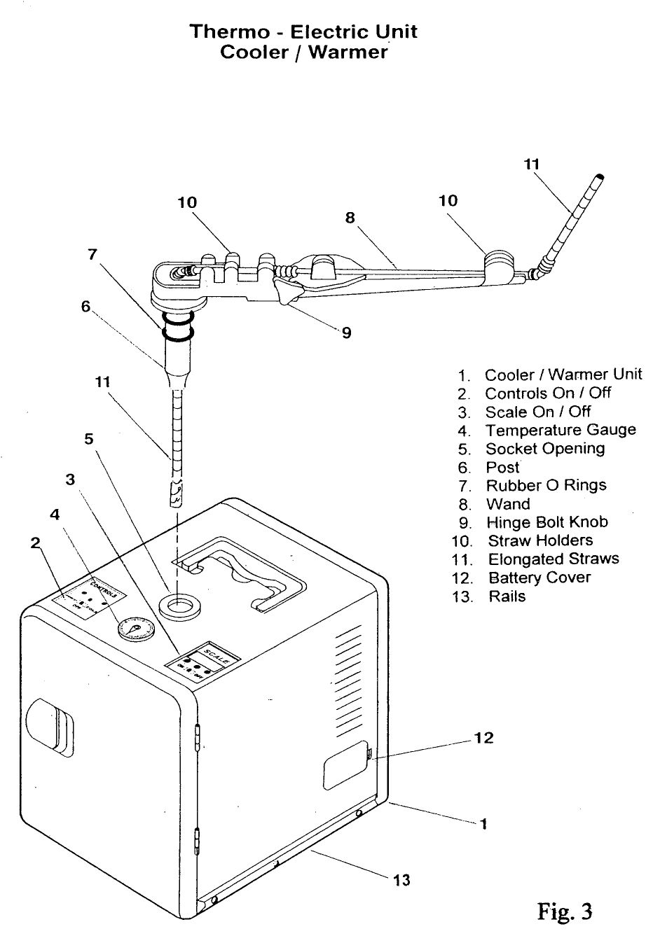

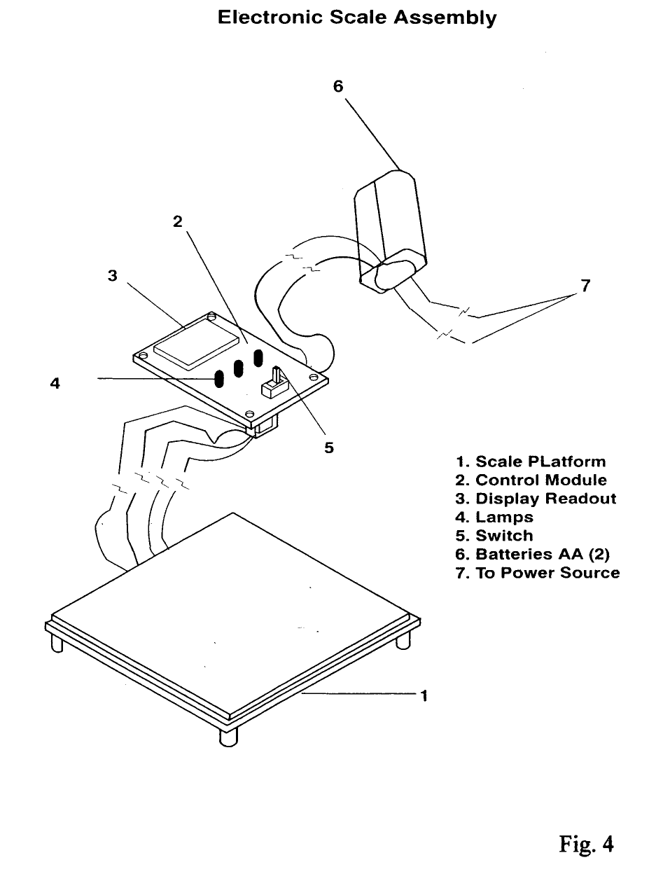

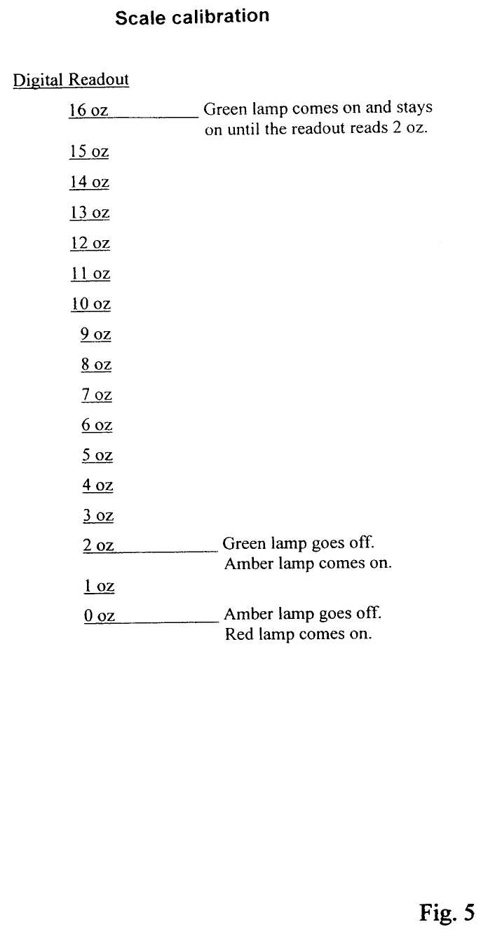

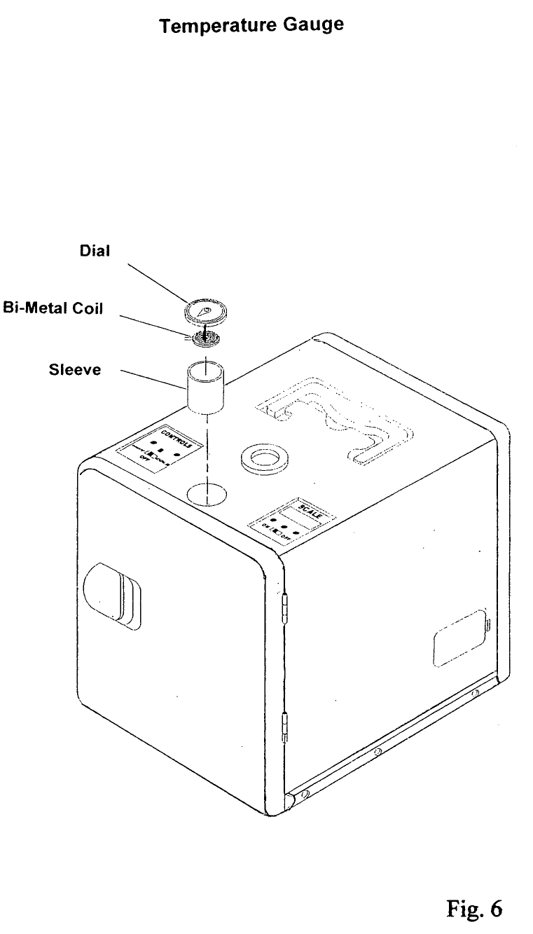

There are numerous thermo electric units on the market designed mainly for recreational use. This invention is not for recreational use. The MedStar thermo electric drink dispenser is designed as a medical equipment device for use in hospitals, nursing facilities and in-home care. Each and every one of the components has a specific purpose related to the medical field. Referring to FIG. 1 of the drawings is a complete view of the low profile drink dispenser with all of the components in place and ready for use. The unit is controlled by an on/off switch. When the switch is in the on/cold position a green lamp comes on, and the inside temperature will reach a constant 40 degrees. When the switch is in the on/hot position a red lamp comes on and the temperature will reach a constant 120 degrees. The temperature is regulated by a built-in thermostat. The temperature is confirmed by the temperature gauge. (See temperature gauge FIG. 6, drawings). Referring to FIG. 2 of the drawings the view is almost the same as FIG. 1 except that the door is open to show the scale placement and the drink container size and shape. The container holds 16 oz of liquid. The scale monitors the amount of liquids consumed, a very important factor in health care facilities. The caregiver simply reads the digital read out and records the result on their chart. The scale control module has an on/off switch, a digital readout and three lamps, one green, one amber and one red. (See scale assembly FIG. 4 drawings). The scale is calibrated to indicate the level of liquid in the container from 16 oz to 0 oz. The lamps give the caregiver a “heads up” as to whether the container is full, low or empty. (See scale calibration FIG. 5, drawings). The wand assembly as shown in exploded view on FIG. 3 of the drawings is a unique system for delivering the liquid in the container to the end user. The apparatus features an adjustable 18 inch long wand with vertical and horizontal movement and a 24 inch long drinking straw that is jointed to follow the contour of the wand.

The MedStar “hands free” drink dispenser is as easy to use as follow:

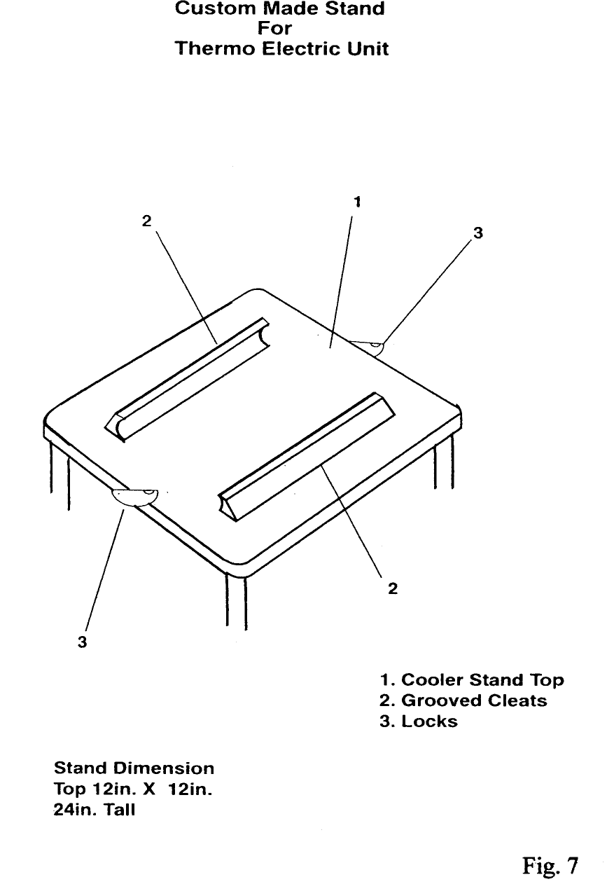

Step 1—Mount the unit on the stand. Close the locks. (See FIG. 7, drawings)

Step 2—Insert the transformer end of the power cord in the AC wall socket. Inset the other end of the power cord in the socket located in the back side of the unit.

Step 3—Lift up and remove the wand. Open the door and place a beverage of choice inside on the scale platform. (cap off)

Step 4—Press the elongated during into the straw holder on the top of the wand and insert the wand into the opening on top of the unit. The straw is disposable.

Step 5—Close the door and turn the on/off switch to cool or warm as desired. The switch is located on the top left side of the unit.

Step 6—Turn the scale on/off switch to the on position. The scale switch is located on the top right side of the unit.

Step 7—The wand has vertical and horizontal movement Adjust to the proper position for the user.

To replace an empty container with a full one, lift out the wand, replace the empty one and reinsert the wand. Caregivers with ordinary basic skills should have no problem using the MedStar thermal electric drink dispenser.

The custom-made stand is an integral part of the MedStar drink dispenser. To use, simply slide the rails, located on the bottom sides of the unit into the grooved cleats located on the top of the stand, then close both locks located on each side of the top of the stand. This will firmly secure the unit and prevent it from sliding or filling off the stand. The invention is defined in the following claim.

What I claim as my invention is:

1. The combination of components that comprise a “hands-free” drink dispenser. The components as delineated are:
1. A very small size 9.5 inches long by 7.5 inches wide by 8½ inches high hot/cold Thermo Electric Unit powered by a 12 foot long electric cord coming from a 110V-12V Transformer which plugs directly into a common electric wall socket
2. An on/off switch mounted front/left on the top of the unit, with a green lamp for cold and a red lamp for hot.
3. A scale with a 3 inch by 3 inch platform placed on the floor inside the door, with ⅛ inch high side rails that position a 16 oz drink container directly beneath the opening on the top of the unit. The electronic scale is powered by both a direct 12V line and two AA batteries in the even that the unit is unplugged. The scale has a control module with an on/off switch, a digital display readout and three lamps colored green, amber and red.
4. A temperature gauge mounted front and center on top of the unit. There is an opening on the top of the unit in which a thin-walled sleeve is inserted followed by the gauge assembly. The temperature sensitive bi-metal coil, which activates the temperature indicator needle comes to rest ⅛ of an inch below the ceiling. The dial rests on top of the opening.
5. The mechanism for the “hands-free” drink dispenser is a post and socket arrangement. A sleeve lined socket is located in an opening 4 inches from front center on the top of the unit. An 18 inch long wand with a series of straw holders is attached to the hollow post. A bolted hinge 4 inches from the center of the post, allows for vertical movement. When the post is inserted in the pocket, two rubber O rings stabilize the horizontal movement of the wand. The jointed 24 inch ⅛ inch ID elongated drinking straw protrudes from the bottom of the drink container, up through the hollow post and is embedded in the straw holders located on the top of the wand.
6. A stand that is an integral part of the MedStar drink dispenser which secures the unit to the top of the stand.
